(19) United States
(12) Patent Application Publication
(10) Pub. No.: US 2024/0288316 A1
(43) Pub. Date: Aug. 29, 2024

(54) APPARATUS AND METHOD FOR NON-INVASIVELY SENSING INTERNAL TEMPERATURE OF A FLUID CONTAINED IN A HOUSING

(71) Applicant: IFD TECHNOLOGIES INC., Vancouver (CA)

(72) Inventors: Mathieu Garret SCHNEIDER, Burnaby (CA); Benjamin Donald Cormac TULINE, Burnaby (CA); James Thomas Isaac LANDECKER, Burnaby (CA); Adrian Bernard SILGARDO, Vancouver (CA); John Paul CHISHOLM, Vancouver (CA); Yen-You LIN, Vancouver (CA); Amanda Mahn Hah TUEY, Vancouver (CA); Jeremy Michael VAN HORN, Vancouver (CA); Audrey Joy Corrine SIEBERT-TIMMER, Vancouver (CA); Thomas Jacob ZUIDERVEEN, Vancouver (CA); Michael Stephen PAULGAARD, Burnaby (CA)

(21) Appl. No.: 18/572,734

(22) PCT Filed: Jun. 17, 2022
(86) PCT No.: PCT/CA2022/050980

§ 371 Date: Dec. 20, 2023

Related U.S. Application Data
(60) Provisional application No. 63/214,695, filed on Jun. 24, 2021.

(51) Int. Cl. G01K 1/14; G01K 1/02; G01K 1/08

(52) U.S. Cl. CPC G01K 1/14; G01K 1/026; G01K 1/08

(57) ABSTRACT

Apparatus and methods for non-invasively determining a temperature of a fluid inside a housing are provided. First and second temperature sensors are positioned so that there is a temperature differential between the first and second temperature sensors. A difference between the temperature of the first and second temperature sensors can be used to estimate the temperature of the fluid inside the housing and/or a zero heat flow methodology can be used to determine the temperature of the fluid inside the housing.

### CROSS-REFERENCE TO RELATED APPLICATIONS

This application claims priority to, and the benefit of, U.S. provisional patent application No. 63/214,695 filed 24 Jun. 2021, the entirety of which is incorporated by reference herein for all purposes.

### TECHNICAL FIELD

Some embodiments relate to an apparatus for measuring temperature. Some embodiments relate to an apparatus for non-invasively determining and/or estimating a temperature of a fluid contained within a housing. Some embodiments relate to methods for measuring temperature. Some embodiments relate to methods for non-invasively determining and/or estimating a temperature of a fluid contained within a housing.

### BACKGROUND

Electrical equipment is a common feature of modern society. Electrical power distribution grids use a variety of electrical equipment, such as transformers, capacitors, reactors and voltage regulators. Electrical equipment such as transformers frequently contains components enclosed within a housing, the housing being filled with a dielectric fluid such as mineral oil, natural or synthetic ester fluids, or silicon oil in order to maintain a stable operating temperature for the electrical equipment, and to prevent or rapidly quench any electric discharges.

Maintaining the operating temperature of the electrical equipment, as reflected by the temperature of the dielectric fluid contained within the housing of the electrical equipment, within a desirable range is important. The life expectancy of electrical equipment such as transformers may be decreased as the operating temperature of the piece of electrical equipment is increased. For example, for some electrical equipment such as transformers, the life expectancy of the equipment may be reduced by as much as one-half for every approximately 5° C. to 10° C. increase in continuous operating temperature that the equipment experiences.

If a piece of electrical equipment is regularly or consistently operating at an elevated temperature, the piece of electrical equipment may fail prematurely (i.e. before the predicted lifespan of the electrical equipment has elapsed). It can be prudent to replace such a piece of electrical equipment with a piece of electrical equipment having a larger load capacity if it is regularly or consistently operating at a temperature higher than the desired operating temperature.

As an example, transformer loss-of-life is a function of both time and temperature, so the longer that a transformer is operating at an over-loaded temperature, the more the expected lifetime of the transformer is reduced. A brief over-load will not have a significant impact on the expected lifetime unless it is at very extreme temperatures; however, frequent over-loading will have a significant impact on the expected lifetime of the transformer. Therefore, if a transformer is slightly over-loaded, utilities will monitor further to determine if this is a regular occurrence or a chance event. If they find it to be a regular occurrence, they may replace the transformer with a larger version designed to handle higher loads. If the transformer is heavily over-loaded, it is a sign that a significant loss-of-life may have already occurred, and that the transformer is likely somewhat over-loaded on a regular basis.

Some utilities have developed practices for optimizing the lifetime of their equipment and the effort required to maintain it. Such practices may involve categorizing over-loaded equipment based on its operating temperature relative to a reference temperature and performing different actions based on such categorization. For example, if a transformer is designed to operate at a reference temperature of 90° C., a transformer may be categorized as ‘over-loaded’ if it is operating at 110° C. and ‘extremely over-loaded’ if it is operating at 120° C. A piece of equipment that is ‘over-loaded’ may be monitored more closely for a period of time, while equipment that is ‘extremely over-loaded’ may be replaced immediately.

There is a need to provide apparatus capable of sensing and communicating changes in temperature within electrical equipment to assist in determining if the electrical equipment is operating in an ‘over-loaded’ or ‘extremely over-loaded’ state. The more rapidly such over-temperature situations can be detected and the relevant power authority notified, the sooner the situation can be addressed, thereby preventing a premature or catastrophic failure of the electrical equipment.

There is also a need to provide an apparatus capable of non-invasively and accurately sensing and communicating changes in temperature within electrical equipment. U.S. Pat. No. 9,395,252 to Frounfelker et al. teaches a system and method for estimating a temperature of a fluid contained in an electrical device without direct thermal communication with the fluid. The method includes measuring a temperature of an exterior wall of a housing of the electrical device, measuring an ambient temperature around the housing, and estimating a temperature of the fluid within the housing using the measured wall temperature and the measured ambient temperature. The method can also purportedly adjust the estimated fluid temperature for ambient humidity conditions.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect provides apparatus for non-invasively estimating a temperature inside a housing. The apparatus has an environmentally shielding portion shaped and configured to shield at least a portion of the housing from prevailing environmental conditions, a first temperature sensing element disposed within the environmentally shielding portion and located to be positionable proximate to the housing when the apparatus is in use, a second temperature sensing element spaced apart from the environmentally shielding portion, the second temperature sensing element located to be positionable proximate to the housing when the apparatus is in use. In some aspects, the second temperature sensing element is largely exposed to prevailing environmental conditions, or is more exposed to prevailing environmental conditions than the first temperature sensing element. In some aspects, the apparatus has a cartridge portion shaped and configured for insertion into a cartridge housing extending inside the housing, the cartridge portion containing the second temperature sensing element. In some aspects, the apparatus has a sensor for determining if the cartridge portion has been inserted into the cartridge housing.

One aspect provides a method of using an apparatus as described above, the method having steps of: determining if the cartridge portion has been inserted into the cartridge housing; if it is determined that the cartridge portion has been inserted into the cartridge housing, using a third thermal sensing element to directly measure the temperature of the fluid contained within the housing; or if it is determined that the cartridge portion has not been inserted in the cartridge housing, using the first and second thermal sensing elements to estimate the temperature of the fluid contained within the housing.

One aspect provides a method of estimating a temperature of fluid contained within a housing, the method having the steps of: measuring a first temperature at a first external location on the housing, the first external location being sheltered from environmental conditions; measuring a second temperature at a second external location on the housing, the second external location being exposed to environmental conditions or being more exposed to environmental conditions than the first external location; and correlating a difference between the first temperature and the second temperature to estimate the temperature of the fluid contained within the housing.

One aspect provides an apparatus for estimating a temperature of fluid contained within a housing, the apparatus having a first thermal sensing element, a second thermal sensing element, a heating element positioned outwardly of both the first and second thermal sensing elements, and thermal insulation differentially positioned relative to the first and second thermal sensing elements.

One aspect provides a method of estimating a temperature of fluid contained within a housing, the method having the steps of: (i) measuring a first temperature at a first location proximate the housing; (ii) measuring a second temperature at a second location, a temperature differential being initially present between the first and second locations; (iii) if the first temperature is different than the second temperature, activating a heating element positioned outwardly of both the first and second locations; (iv) repeating steps (i) through (iii) until it is determined that the first and second temperatures are the same; and (v) determining the temperature of the fluid contained within the housing to be the same as the first and second temperatures.

One aspect provides an apparatus for estimating a temperature of fluid contained within a housing, the apparatus having a first thermal sensing element, a second thermal sensing element; and thermal insulation positioned to be located between the housing and the second thermal sensing element when the apparatus is in use.

One aspect provides a method of estimating a temperature of fluid contained within a housing, the method having the steps of: measuring a first temperature at a first location on the housing; measuring a second temperature at a second location, thermal insulation being positioned between the housing and the second location; and estimating the temperature of the fluid contained within the housing based on the relationship between the first temperature and the second temperature.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows an exemplary embodiment of a piece of electrical equipment, namely a transformer.

FIG. 2A shows a second exemplary embodiment of a piece of electrical equipment, namely a transformer, with an internal recess formed therein. FIG. 2B is a cross-sectional view thereof taken along line 2B-2B.

FIG. 3A shows a sectional view of an exemplary embodiment of a temperature sensor that can be used to estimate the temperature of fluid within a housing using a zero heat flow methodology. FIG. 3B shows a sectional view of a second exemplary embodiment of a temperature sensor that can be used to estimate the temperature of fluid within a housing using a zero heat flow methodology.

FIG. 4 shows an exemplary embodiment of a method of estimating the temperature of fluid within a housing using a zero heat flow methodology.

FIG. 5A shows a sectional view, FIG. 5B shows an enlarged sectional view and FIG. 5C shows a partial perspective view of an exemplary embodiment of a temperature sensor that can be used to estimate the temperature of fluid within a housing using a temperature differential or Delta T method.

FIG. 6 shows an exemplary embodiment of a method of estimating the temperature of fluid within a housing using a temperature differential or Delta T methodology.

FIG. 7 shows an example embodiment of determining whether a temperature sensor has been installed to directly measure or to estimate a temperature of a fluid contained within a housing.

FIG. 8 shows an example embodiment of a method of estimating the temperature of fluid within a housing using a temperature differential or Delta T methodology incorporating a compensation factor for the ambient environmental temperature.

FIG. 9 shows an example embodiment of a temperature sensor that can be used to estimate a temperature of a fluid contained within a housing using a modified zero heat flow methodology.

FIG. 10 shows an example embodiment of a method of estimating the temperature of fluid within a housing using a hybrid zero heat flow and temperature differential or Delta T methodology.

FIG. 11 shows an example embodiment of a temperature sensor having a wired connection.

FIG. 12 shows an example test demonstrating the correlation between the estimated internal temperature versus the measured temperature of a housing.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As used herein, “environmental conditions” can include any external environmental parameter that may affect an internal temperature of a fluid contained within a housing or any combination of such parameters. Examples of environmental conditions include the prevailing environmental temperature, humidity, wind conditions, precipitation, solar radiation, and the like, including any combination of such conditions. For example, the housing and any fluid contained within a housing may be subject to greater cooling effects due to a combination of cold and wind, as compared with the cooling effects that might be experienced with only cold or only wind per se.

As used herein, “external” means the outer surface of a housing and “internal” means the inner surface or interior portion of the housing. “Outward” means in a direction away from the internal portion of the housing.

As used herein, the term “adjacent” or “proximate” can mean directly contacting, or can mean in close enough contact through any interposing elements or space that for example a temperature sensor can still measure an approximation of the temperature of the surface to which it is “adjacent” or “proximate”.

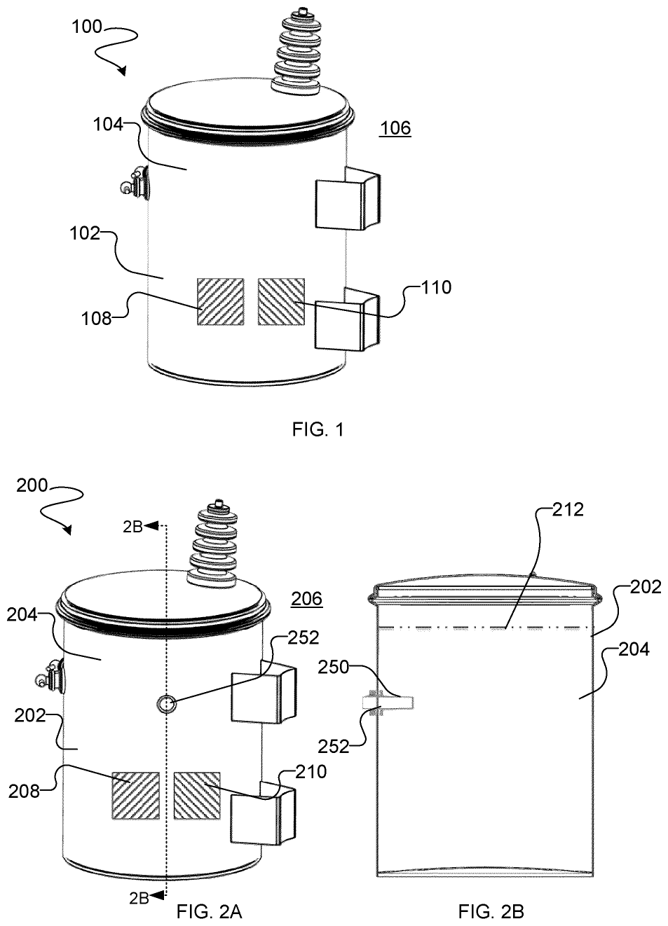

With reference to FIG. 1, an exemplary piece of electrical equipment being a transformer 100 is illustrated. Transformer 100 has a tank or housing 102 that encloses a fluid 104 within its interior. Fluid 104 is fluidly separated by housing 102 from an external environment 106 surrounding housing 102. That is, fluid 104 is sealed within housing 102 so that it is largely not permitted to escape housing 102. In some cases, fluid 104 can be hazardous to the environment (for example fluid 104 may be a recognized greenhouse gas or may have deleterious or harmful effects on various organisms), so that it is important to keep fluid 104 largely contained within housing 102 although some fluid 104 might be vented if the pressure within transformer 100 builds above a certain level and activates any pressure relief valve associated with transformer 100. In some embodiments depending on the design and regulations applicable to a particular transformer 100, housing 102 may be open to the external environment to a limited extent to allow for pressure equalization, for example via an aspiration tube. In some embodiments, the aspiration tube can be plugged with mineral wool or other substance that allows air to pass but that restricts the passage of fluid 104 therethrough.

Fluid 104 can be any suitable electrically insulating or dielectric fluid suitable for use in electrical equipment, including mineral oil, natural or synthetic ester fluids, silicon oil, or gases such as SF₆, or the like.

Housing 102 can be any suitable tank or housing for a piece of electrical equipment such as a transformer like transformer 100. In some embodiments, housing 102 is made from carbon steel, stainless steel, or any other suitable material. Different styles of housings 102 for different transformers 100 can vary in a number of different design aspects, for example the thickness of the housing, the material from which the housing is made, the thermal conductivity of the material from which the housing is made, the type and thickness of the protective coating provided on the housing (e.g. paint), the size and dimensions of the housing (e.g. volume, height, length, width, diameter, and so on), the shape of the housing (e.g. round or rectangular), the fluid circulation pattern of fluid within the housing, and the like.

In the illustrated embodiment, a first portion of housing 102, illustrated schematically as 108, is shielded from the impact of environmental conditions, while a second portion of housing 102, illustrated schematically as 110, is exposed to the impact of environmental conditions.

With reference to FIG. 2A and FIG. 2B, an alternative embodiment of a transformer 200 with a housing 202 having an inlet 250 containing a cartridge housing 252 therein is illustrated. Transformer 200 is otherwise similar to transformer 100, and like elements have been illustrated with like reference numerals incremented by 100 and are not further described again including fluid 204, external atmosphere 206, shielded portion 208 and exposed portion 210 of housing 202. In the illustrated embodiment, cartridge housing 252 is placed in sealed engagement with housing 202 about inlet 250, to prevent the escape of fluid 204 from the interior space of housing 202. The fluid level 212 of fluid 204 is shown by a dashed line in FIG. 2B, and this can be referred to as the top oil level.

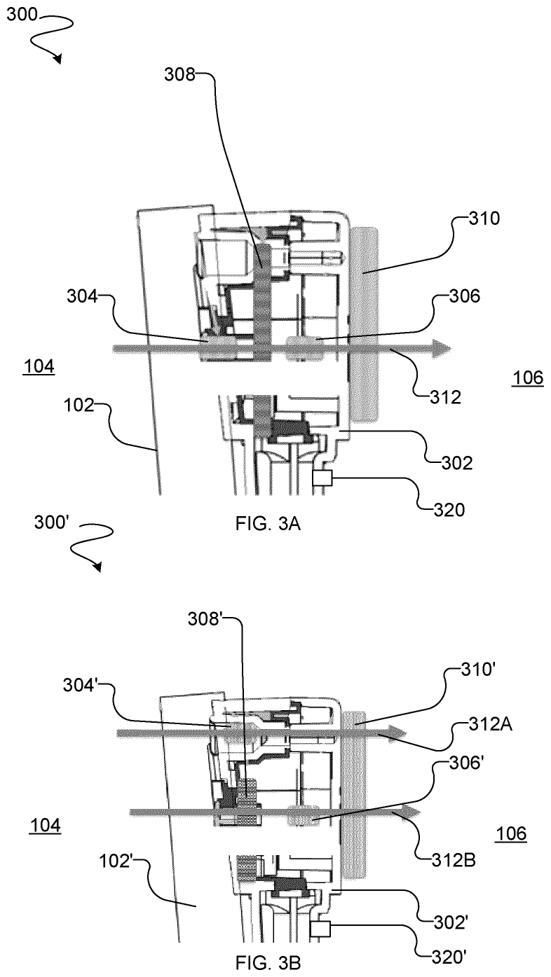

With reference to FIG. 3A, an example embodiment of a temperature sensor 300 that can be used to determine the temperature of fluid 104 or 204 within transformer 100 or 200 using the zero-heat-flow method described below is provided. The zero-heat-flow method uses two temperature sensing elements to determine the heat flux or heat flow through housing 102 or 202 and compensates for that heat loss using an actively powered heater.

Temperature sensor 300 has a body 302 that is shaped and configured to be mountable to the housing of an electrical device, e.g. housing 102. Temperature sensor 300 is provided with first and second temperature sensing elements 304 and 306 which are spaced apart from one another and separated by a layer of thermal insulation 308.

Because first temperature sensing element 304 is exposed more directly to the housing 102 while temperature sensing element 306 is thermally shielded from the heat exiting housing 102 by thermal insulation 308, that is because thermal insulation 308 is differentially positioned relative to the first and second thermal sensing elements when temperature sensor 300 is in use, a temperature differential is produced between first and second temperature sensing elements 304, 306 when temperature sensor 300 is in use.

Any suitable temperature sensor can be used for first and second temperature sensing elements 304, 306, for example a thermocouple, resistive thermal device (RTD) sensor, thermistor, semiconductor-based integrated circuit, or the like. Any suitable material can be used to provide thermal insulation 308, for example foam, entrapped air, materials forming part of or components of temperature sensor 300, or the like. The insulation value provided by thermal insulation 308 should remain constant throughout the use of temperature sensor 300, so that calibration of temperature sensor 300 as described below can be used to determine the temperature of fluid 104 or 204 within housing 102 or 202 as described herein. E.g. the components that form part of thermal insulation 308 should not be removed or modified in a manner that might change the insulation value provided by thermal insulation 308.

A heating element 310 is provided outwardly of second temperature sensing element 306. Temperature sensor 300 is configured so that first temperature sensing element 304 can be placed in or close to thermal contact with housing 102. Thermal insulation 308 is positioned outwardly of first temperature sensing element 304, so that heat moving outwardly along the path of heat flow (illustrated by arrow 312) must pass through thermal insulation 308 to reach second temperature sensing element 306, which is positioned outwardly on body 302 from thermal insulation 308. Finally, any heat passing through second temperature sensing element 306 along the path of heat flow 312 will reach heating element 310. As a result of this configuration, there will be a difference in the temperature measured by each of first temperature sensing element 304 and second temperature sensing element 306, which reflects a portion of the temperature gradient from the fluid 104 to the external environment 106.

The surface area of housing 102 that is covered by temperature sensor 300 should be sufficiently large that a significant amount of heat is not lost along paths of travel other than the path of heat flow 312—that is, if the surface area of housing 102 that is covered by temperature sensor 300 is too small, then heat will move not only along the path of heat flow 312, but also in directions orthogonal thereto, meaning that the temperature measured by second temperature sensing element 306 may be lower than would be the case if heat flowed only along path of heat flow 312. Likewise, the surface area that is covered by thermal insulation 308 and heating element 310 should be sufficiently large to ensure that a significant amount of heat is not lost along paths of travel other than the path of heat flow 312.

In use, heat is applied to the system using heating element 310 until there is no temperature gradient between the first and second heat sensing elements 304, 306. Such situation implies that heat has stopped flowing along the path of heat flow 312, so that all of the first and second temperature sensing elements 304, 306 and thermal insulation 308 are at the same temperature, as is the fluid 104 inside housing 102. At this stage, the reading of temperature sensors 304, 306 will correspond to the temperature of fluid 104.

Alternative configurations can be used to determine the temperature of fluid 104 or 204 within transformer 100 or 200 using a zero-heat-flow method, so long as the temperatures initially measured by first and second temperature sensing elements 304, 306 are different due to differing degrees of insulation interposing each of first and second temperature sensing elements 304, 306 and either housing 102 or heating element 310 (i.e. so that a temperature differential is established between first and second temperature sensing elements 304, 306, which may be because thermal insulation 308 is differentially positioned relative to first and second temperature sensing elements 304, 306).

For example, with reference to FIG. 3B, an alternative embodiment of a temperature sensor 300′ in which first and second temperature sensing elements 304′, 306′ are laterally spaced apart from one another is illustrated. In the illustrated embodiment, first temperature sensing element 304′ is proximate to housing 102′ of the transformer within body 302′ but without any significant insulating material interposing first temperature sensing element 304′ and housing 102′, so that the temperature measured by first temperature sensing element 304′ is reflective of or approximates more closely the temperature of housing 102′. Second temperature sensing element 306′ is spaced apart from housing 102′ by thermal insulation 308′, so that a temperature differential is established between first temperature sensing element 304′ and second temperature sensing element 306′ by reason of the differential positioning of thermal insulation 308′ (i.e. first temperature sensing element 304′ will be more affected by changes in the in the temperature of internal fluid 104 than will second temperature sensing element 306′). As for thermal insulation 308, any suitable material can be used to provide thermal insulation 308′, for example foam, entrapped air, materials forming part of or components of temperature sensor 300′, or the like.

While in the illustrated embodiment second temperature sensing element 306′ is illustrated as being positioned farther outwardly from housing 102′ than first temperature sensing element 304′, in alternative embodiments the first and second temperature sensing elements could be positioned the same distance outwardly from housing 102′, or the second temperature sensing element 306′ could actually be positioned closer to housing 102′, so long as the thermal insulation value of the material between second temperature sensing element 306′ and housing 102′ is greater than the amount of thermal insulation value of the material positioned between first temperature sensing element 304′ and housing 102′, to provide a temperature differential between the first and second temperature sensing elements 304′, 306′.

Likewise in the illustrated embodiment, while thermal insulation 308′ has been illustrated as being positioned between second temperature sensing element 306′ and housing 102′ to provide the differential positioning of thermal insulation 308′ relative to first and second temperature sensing elements 304′, 306′, in alternative embodiments the temperature differential between first and second temperature sensing elements 304′, 306′ could be produced by positioning thermal insulation 308′ instead between first temperature sensor 304′ and heating element 310′.

Further alternative embodiments could be developed that produce a temperature differential between sensing elements 304′ and 306′ when heat is flowing by positioning thermal insulation in different orientations around the sensors to provide the differential positioning, for instance by shielding first temperature sensing element 304′ from lateral heat flow to a greater extent than second temperature sensing element 306′.

In the case of temperature sensor 300′, heat flows out of housing 102′ and past first temperature sensing element 304′ along a first path of heat flow 312A, while heat flows out of housing 102′, past thermal insulation 308′, and then past second temperature sensing element 306′ along a second path of heat flow 312B. Again, the difference in temperature measured by each of first temperature sensing element 304′ and second temperature sensing element 306′ is reflective of a portion of the temperature gradient from fluid 104 to external environment 106, and can likewise be used in conjunction with the application of heat from heating element 310′ until there is no temperature gradient between the first and second heat sensing elements 304′, 306′. Upon reaching such situation, this implies that heat has stopped flowing along both path of heat flow 312A and path of heat flow 312B so that all of first and second temperature sensing elements 304′, 306′ and thermal insulation 308′ are at the same temperature, as is fluid 104 inside housing 102′. Again, at this point, the reading of temperature sensors 304′, 306′ corresponds to the temperature of fluid 104.

In further alternative embodiments, the shape and configuration of heating element 310 or 310′ could be varied. For example in some embodiments, heating element 310 or 310′ could be circular or oval in shape optionally with an aperture through the centre thereof (e.g. provided with a doughnut shape), to minimize the amount of heat that passes laterally away from path of heat flow 312 (or 312A/312B). In other embodiments, both of the first and second temperature sensing elements could be spaced apart at the same or approximately the same distances from the housing, but with thermal insulation positioned only between the second temperature sensing element and the housing (i.e. not between the first temperature sensing element and the housing) or thermal insulation positioned only between the first temperature sensing element and the heating element (i.e. not between the second temperature sensing element and the heating element) to provide a temperature differential between the two temperature sensing elements.

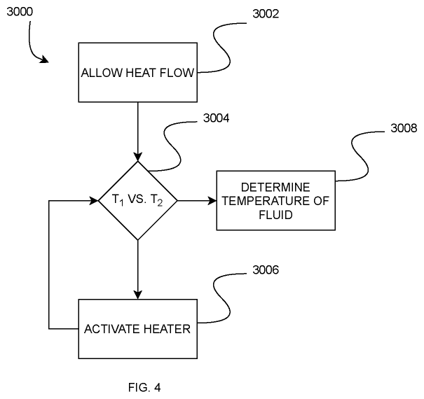

Temperature sensor 300 or 300′ can be used in a method 3000 illustrated in FIG. 4 for estimating the temperature of fluid within a housing using a zero heat flow methodology. Initially at 3002, heat flows from fluid 104 outwardly through housing 102 towards the external environment 106 along path of heat flow 312 (or 312A/312B) Because of the presence of thermal insulation 308 or 308′, the amount of heat reaching second temperature sensing element 306 or 306′ will be less than the amount of heat reaching first temperature sensing element 304 or 304′, and the temperature T₂ measured by second temperature sensing element 306 or 306′ will be lower than the temperature T₁ measured by first temperature sensing element 304 or 304′.

At 3004, if it is determined that T₁ is greater than T₂, heating element 308 will be activated to supply heat at 3006. Steps 3004 and 3006 will be repeated until it is determined at step 3004 that T₁ is the same as T₂. At that point, it will be concluded at step 3008 that the temperature of fluid 104 inside housing 102 is the same as both that T₁ and T₂. In the event that it is determined at step 3004 that T₂ is greater than T₁, heating element 308 can stop applying heat and step 3004 can be repeated until such time as it is determined at step 3004 that T₁ is again greater than T₂ (at which point step 3006 can be repeated) or until such time as it is determined at step 3004 that T₁ is equal to T₂, at which point it can be concluded at step 3008 that the temperature of fluid 104 inside housing 102 is the same as both that T₁ and T₂.

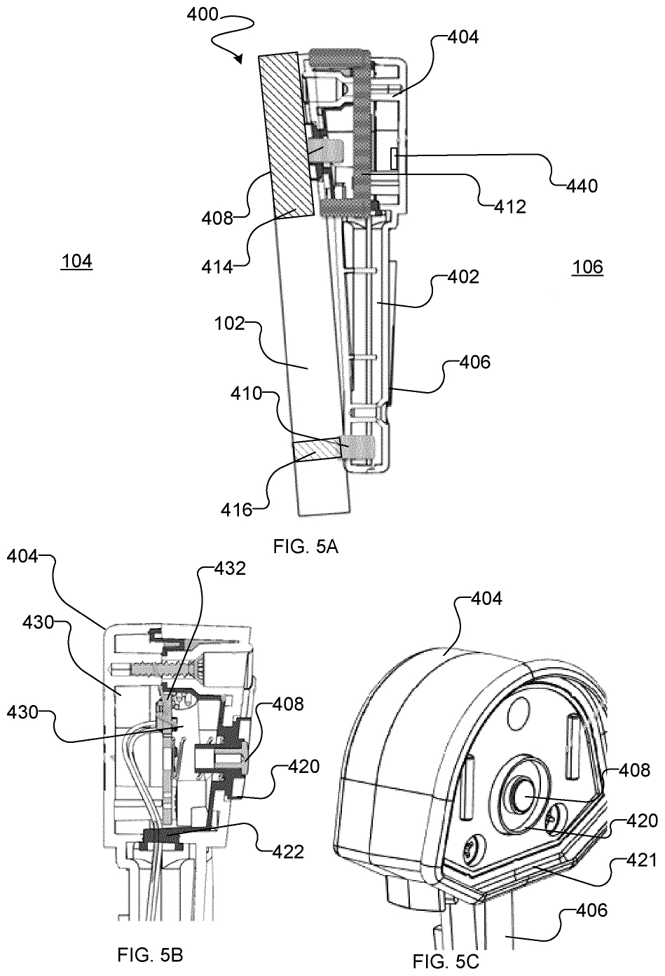

With reference to FIGS. 5A, 5B and 5C, an example embodiment of a temperature sensor 400 that can be used to estimate the temperature of fluid 104 within housing 102 using a temperature differential or Delta T method is shown. Sensor 400 has a body 402 which has a first portion or head 404 and a second portion stem 406. In the illustrated embodiment, head 404 is positioned vertically above stem 406, although it will be appreciated that the relative positions of these components could be varied depending on the orientation of sensor 400.

Sensor 400 has a first or head temperature sensing element 408 positioned in head 404 so that head temperature sensing element 408 can be placed in thermal contact with housing 102 when sensor 400 is in an installed configuration, as shown in FIG. 5A. Sensor 400 also has a second or stem temperature sensing element 410, which is positioned within stem 406 so that stem temperature sensing element 410 can be placed in thermal contact with housing 102 when sensor 400 is in the installed configuration. Any suitable temperature sensor can be used for first and second temperature sensing elements 408, 410, for example a thermocouple, resistive thermal device (RTD) sensor, thermistor, semiconductor-based integrated circuit, or the like.

A thermally insulating and environmentally shielding barrier, shown schematically as 412 in FIG. 5A, is provided in head 404, to protect head temperature sensing element 408 and the corresponding shielded portion 414 of housing 102 to which head 404 is affixed from the external environment when sensor 400 is in the installed configuration. Thus, head temperature sensing element 408 and the corresponding shielded portion 414 of housing 102 to which head 404 is affixed are protected from the external environment when sensor 400 is in the installed configuration.

In contrast, no such thermally insulating or environmentally shielding barrier is provided on stem 406. Further, the surface area of stem 406 that contacts housing 102 is relatively small, so that the portion 416 of housing 102 that is contacted by stem temperature sensing element 410 is relatively exposed to the external environment.

With further reference to FIGS. 5B and 5C, one example embodiment of a thermally insulating and environmentally shielding barrier that is a physical barrier is shown in more detail. In the illustrated embodiment, head temperature sensing element 408 is circumferentially surrounded by an inner circumferential gasket 420. The outer periphery of the portion of head 404 that contacts housing 102 is likewise circumferentially surrounded by an outer circumferential gasket 421. The inner and outer circumferential gaskets 420, 421 can help to prevent or minimize the effect of certain environmental conditions such as wind, rain and solar radiation by physically preventing and/or reducing the ingress of such environmental elements to head temperature sensing element 408 and portion 414 of housing 102 to which head 404 is affixed. This minimizes the effect of such environmental elements on the temperature of portion 414 of housing 102 and minimizes the effect of such environmental elements on head temperature sensing element 408.

The inner and outer circumferential gaskets 420, 421 do not need to achieve a 100% sealing effect against the outer surface of housing 102 to achieve such minimization. The material of body 402 of head 404 and the components contained therein (e.g. entrained air 430, circuit board 432, internal gasket 422, and the like) alone make it difficult for wind, rain and solar radiation to access the portion 414 of the external surface of housing 102 to which head 404 is affixed. Addition of inner and/or outer circumferential gaskets can enhance the blocking of such environmental elements that is provided by head 404, although in some embodiments either or both of the inner and/or outer circumferential gaskets could be removed. Head 404 should be designed to cover a sufficient amount of surface area 414 to shield a sufficiently large surface area of housing 102 to ensure that head temperature sensing element 408 is sensing a shielded temperature. Thus, heat flow laterally through the wall of housing 102 from shielded portion 414 should be sufficiently low to allow the shielded temperature to be properly determined.

Head temperature sensing element 408 is also thermally shielded from the external environment. In the illustrated embodiment, the material of body 402 of head 404 and the components contained therein (e.g. entrained air 430, circuit board 432, inner gasket 422, the walls of body 402, inner and outer circumferential gaskets 420 and 421, and the like) make it difficult for wind, rain and solar radiation to access the portion 414 of the external surface of housing 102 to which head 404 is affixed, and also collectively act as thermal insulation to thermally shield head temperature sensing element 408 from the external environment. This collectively shields head temperature sensing element 408 and shielded portion 414 of housing 102 against the impact of ambient temperature and environmental conditions.

In contrast to head temperature sensing element 408, stem temperature sensing element 410 is not shielded from the external environment, and any shielding provided by stem 406 is minimized, for example by stem 406 having a relatively narrow width and small size compared to head 404.

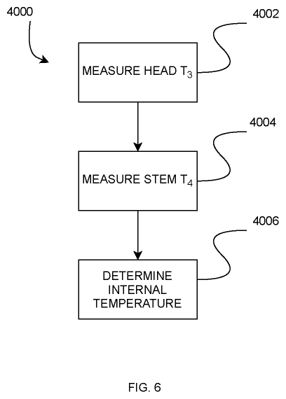

With reference to FIG. 6, a method 4000 of estimating the internal temperature of fluid 104 using a temperature differential or Delta T methodology is illustrated. Sensor 400 can be used to carry out some embodiments of method 4000. At 4002 head temperature sensing element 408 measures the temperature T₃ of shielded portion 414 of housing 102.

At 4004, stem temperature sensing element 410 measures the temperature T₄ of exposed portion 416 of housing 102.

Because T₃ is measured on the shielded portion 414 and T₄ is measured on the exposed portion 416, the temperatures will differ from one another. The difference between the temperatures or Delta T is a function of parameters such as the temperature of fluid 104 and the impact of external environment 106 on the cooling of transformer 100. The head temperature sensing element 408 and stem temperature sensing element 410 can be calibrated using reference transformers operating with a known temperature of fluid 104. Using the known reference measurements, the correlation between T₃ and T₄ can be used to derive a relationship between these two measurements and the internal temperature of fluid 104, so that the difference between T₃ and T₄ can be used in the field at step 4006 to predict the temperature of fluid 104.

In some embodiments, internal oil temperature is estimated using a transfer function, which can take a number of mathematical forms, such as power, linear, etc. If a power equation is used, it could look like the following Equation (1):

$${T}_{Oil} = {A ( {T}_{S} - {T}_{E} )}^{- B} \qquad ( 1 )$$

### Where

Tₒᵢₗ is the estimated oil temperature
T_{S} is the shielded tank temperature
T_{E} is the exposed tank temperature
A and B are empirically derived coefficients
   If a linear function is used, it could take the following form of Equation (2):

$${T}_{Oil} = A + B {T}_{S} + C {T}_{E} \qquad ( 2 )$$

### Where

Tₒᵢₗ is the estimated oil temperature
T_{S} is the shielded tank temperature
T_{E} is the exposed tank temperature
A, B and C are empirically derived coefficients

The foregoing equations for estimating the internal oil temperature are exemplary only. The person skilled in the art would be able to determine alternative transfer equations using forms other than power or linear which would produce similarly effective results given the same inputs of T_{S} and T_{E} (corresponding to T₃ and T₄ described above).

In some embodiments, stem 406 of temperature sensor 400 is shaped and configured to be insertable into cartridge housing 252. In such embodiments, when transformer 200 is equipped with cartridge housing 252, temperature sensor 400 can be inserted therein. In such configuration, stem temperature sensing element 410 is positioned inside the interior of housing 202 during use, and is able to directly or nearly directly measure the temperature of fluid 204 within the interior space of housing 202. Thus, a measurement of the actual temperature of fluid 204 within housing 202 can be made.

In one example embodiment, temperature sensor 400 can be used in a method of developing calibration coefficients that can be used to estimate the internal temperature of fluid within transformers like transformer 100 that do not contain any aperture or orifice through which an internal temperature can be determined. For example, the calibration of a particular transformer 100 with respect to the difference between T₃ and T₄ measured by head temperature sensing element 408 and stem temperature sensing element 410 when sensor 400 is mounted externally on transformer 102 or 202 may depend on various parameters associated with transformer 100 or housing 102, including the thickness of the walls of housing 102, the paint coating applied, the type of metal from which housing 102 is made, and the like. Calibration should be conducted separately for each transformer 100 for which these parameters are varied, but calibration carried out on one transformer 100 having a particular set of these parameters (i.e. on one particular style of transformer) will be valid across other transformers 100 that share the same set of parameters. The same principles can be applied to develop calibration coefficients for determining an internal temperature of fluid contained in other pieces of electrical equipment or device.

Sensor 400 can be used to carry out such calibration by inserting the stem 406 of a first such sensor 400 into the cartridge housing 252 of a transformer 200, and also mounting a second such sensor 400 externally on housing 202. The transformer 200 can be subjected to a plurality of different temperature and environmental conditions to determine the respective different values of T₃ and T₄ measured by the head and stem temperature sensors 408, 410 of the second sensor 400 at a plurality of different temperatures or under different environmental conditions, and comparing the values of T₃ and T₄ from the second sensor with the measured value of the temperature of fluid 204 inside housing 202 measured by the stem temperature sensing element 410 of the first such sensor acting as a third temperature sensor (or by in any other way directly measuring the internal temperature of fluid 204 inside housing 202). Using the measured data, the coefficients of the equation used to model the internal temperature of the tank versus T₃ and T₄ could be determined.

In one example embodiment, temperature sensor 400 further includes an orientation sensor such as a gyroscope or contact sensor, schematically illustrated as sensor 440. Examples of sensors that can be used for sensor 440 include: a tilt switch to determine if sensor 400 is mounted vertically (indicating external mounting) or horizontally (indicating mounted inside cartridge housing 252); a reed switch with magnet; logic rules based on the measured temperature, e.g. if the stem sensor is at a higher temperature than the head sensor, likely sensor 400 is installed in cartridge housing 252, whereas a reverse temperature condition suggests external mounting; an accelerometer; a physical switch that is switched when sensor 400 is installed in a particular configuration; a light gate or other digital switch that is triggered in one mounting position but not the other; and so on.

Orientation sensor 440 can be used to determine if temperature sensor 400 has been mounted to the exterior of a housing, or if temperature sensor 400 has been inserted into cartridge housing 252. If orientation sensor 440 determines that temperature sensor 400 has been inserted into cartridge housing 252, then stem temperature sensing element 410 can be used to directly measure the internal temperature of the housing, and further can be used as the third sensor if carrying out calibration for a particular transformer 200. If orientation sensor 440 determines that temperature sensor 400 has been mounted to the exterior of a housing, then temperature sensing elements 408 and 410 are used to make an estimate of the internal temperature of the fluid within the housing, e.g. by carrying out method 4000.

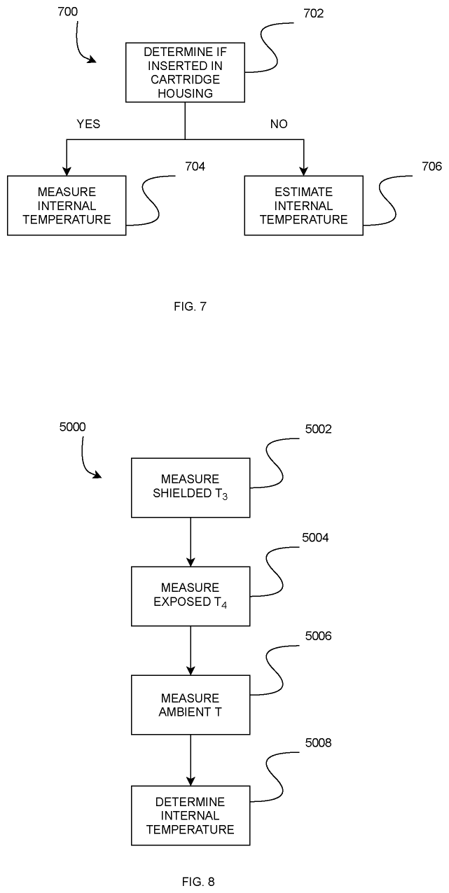

For example, with reference to FIG. 7, method 700 can be used to determine how a temperature sensor like temperature sensor 400 has been installed and make a determination of a temperature of a fluid contained within a housing accordingly. At 702, it is determined whether the stem 406 of temperature sensor 400 has been inserted into a cartridge housing within the electrical device. At 704, if it is determined that the stem 406 of temperature sensor 400 has been inserted into the cartridge housing 252, the temperature of the fluid contained within the housing is determined directly using stem temperature sensing element 410. At 706, if it is determined that the stem 406 of temperature sensor 400 has not been inserted into cartridge housing 252, then thermal sensing elements 410 and 412 separated by thermal insulation 414 are used to make an estimate of the internal temperature of the fluid within the housing, e.g. by carrying out method 4000.

In some embodiments, a method for estimating the temperature of fluid 104 using a temperature differential or Delta T methodology incorporating an additional compensation factor based on the ambient environmental temperature is provided. An example of such method 5000 is illustrated in FIG. 8. Method 5000 can be carried out using any suitable apparatus for determining the temperature of housing 102 at a shielded location 108 and at an exposed location 110 (e.g. temperature sensor 400), as well as any suitable apparatus for determining ambient environmental temperature, e.g. a thermocouple, resistive thermal device (RTD) sensor, thermistor, semiconductor-based integrated circuit, or the like. The ambient temperature can be used as an additional variable in method 5000 to correlate the three measured temperatures to the temperature of fluid 104, for example by including the ambient temperature in equations similar to Equations (1) and (2) and using known reference measurements as described above for the temperature differential or Delta T methodology described with reference to method 4000 to derive a correlation between T₃, T₄ and the ambient temperature, and the temperature of fluid 104.

In method 5000, at 5002, the temperature of the shielded location 108 (corresponding to T₃ described with reference to method 4000) is determined. At 5004, the temperature of the exposed region 110 (corresponding to T₄ described with reference to method 4000) is determined. At 5006, ambient temperature is determined. At 5008, the internal temperature of fluid 104 is estimated based on the measurements of T₃, T₄ and ambient environmental temperature.

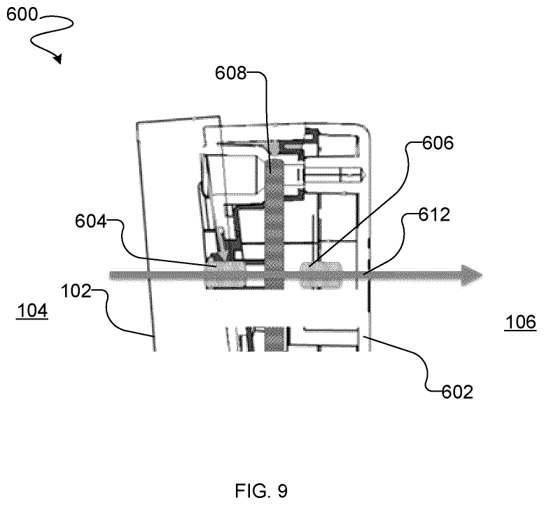

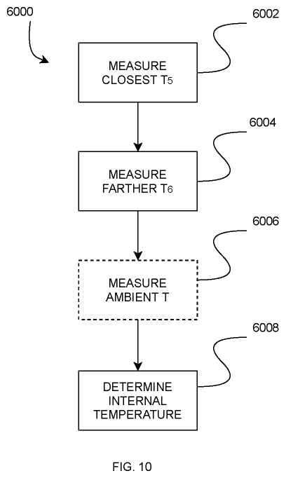

With reference to FIG. 9, an example embodiment of a temperature sensor 600 that can be used to estimate the internal temperature of fluid 104 using a hybrid zero heat flow temperature differential methodology is illustrated. Temperature sensor 600 has a body 602 and is configured to be mountable on the external surface of housing 102. A first temperature sensing element 604 is positioned to be mountable adjacent the external surface of housing 102, and then similar to temperature sensor 300, a layer of thermal insulation 608 is positioned outwardly from first temperature sensing element 604, and then a second temperature sensing element 606 is positioned outwardly from thermal insulation 608. Heat thus flows outwardly from housing 102 along the path of heat flow represented by arrow 612.

Temperature sensor 600 differs from temperature sensor 300 in that a heating element is omitted. Thus, rather than using applied heat from a heating element to use a zero heat flow methodology to calculate the internal temperature of fluid 104, temperature sensor 600 uses the calibration of the temperature difference between first and second temperature sensing elements 604, 606 under a series of known internal temperature conditions to develop an equation that can be used to model and predict the temperature of fluid 104 based on the temperature difference between first and second temperature sensing elements 604, 606.

In some embodiments, a method for estimating the temperature of fluid 104 using a hybrid zero heat flow and temperature differential or Delta T methodology is provided. In some embodiments, such method can incorporate an additional compensation factor based on the ambient environmental temperature, similar to method 5000. An example of such method 6000 is illustrated in FIG. 10. Method 6000 can be carried out using temperature sensor 600. In some embodiments, any suitable apparatus for determining ambient environmental temperature, e.g. a thermocouple, resistive thermal device (RTD) sensor, thermistor, semiconductor-based integrated circuit, or the like, can also be used if ambient temperature is to be used in estimating the internal temperature of fluid 104.

At 6002, the temperature of the first temperature sensing element 604 that is positioned closest to housing 102 T₅ is determined. At 6004, the temperature of the second temperature sensing element 606 that is positioned farther from housing 102 T₆ is determined. At 6006, ambient temperature is optionally determined. At 6008, the internal temperature of fluid 104 is estimated based on the measurements of T₅ and T₆ based on previously derived coefficients for the piece of electrical equipment. In some embodiments, if ambient environmental temperature is measured at step 6006, then at step 6008 the internal temperature of fluid 104 is estimated based on all of T₅, T₆ and the measured ambient temperature.

In some embodiments, temperature sensor 300 or 400 can be equipped with a light, illustrated schematically as 320/320′/420, or other visual indicator that provides an indication that the external temperature of a housing has exceeded a temperature that is beyond a predetermined temperature threshold, e.g. a threshold beyond which it is not safe for a person to touch the external surface of the housing.

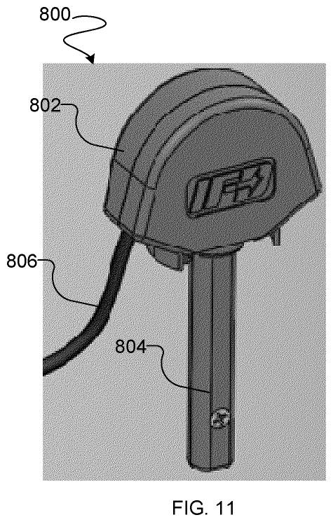

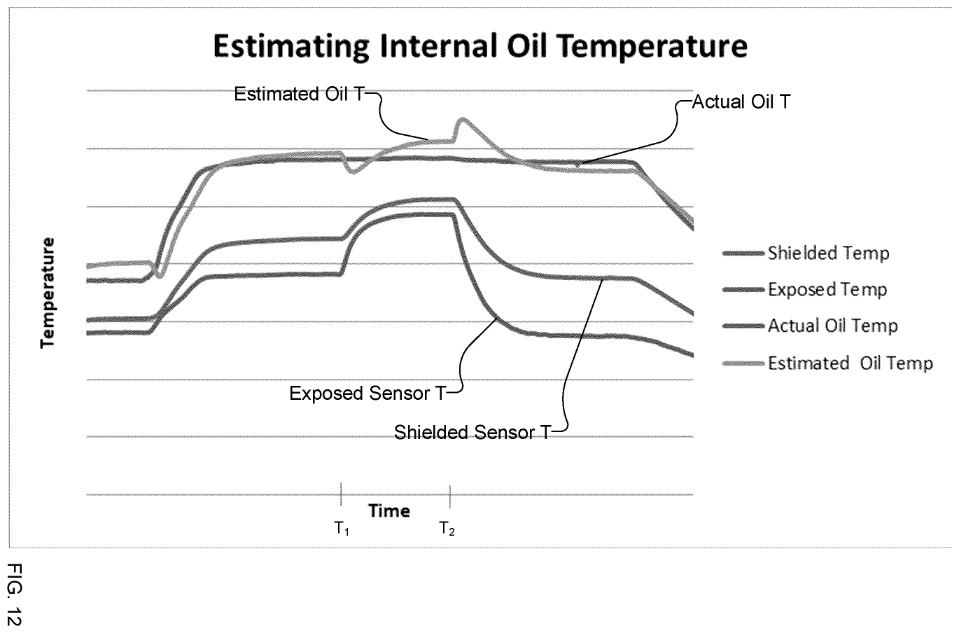

In some embodiments, as shown with respect to temperature sensor 800 illustrated in FIG. 11, any of the temperature sensors described herein can also be provided with a wired connection 806, to allow connection for example to a digital sensor bus or other processor or communications module. Temperature sensor 800 has a head 802 and stem 804. Wired connection 806 allows temperature sensor 800 to relay information about the temperature sensed to a controller or other processor. In alternative embodiments, a wireless communications module could allow temperature sensor 800 to relay information about the temperature sensed to a controller or other processor equipped with a parallel wireless communications module. In some such embodiments, wired connection 806 could be omitted.

### EXAMPLES

Certain embodiments are further described with reference to the following examples, which are intended to be illustrative and not limiting in nature.

### Example 1.0 Comparing Estimated and Actual Internal Temperatures

The inventors conducted a test using an embodiment of temperature sensor 400 to estimate the internal temperature of fluid within a housing using method 4000. A control measurement of the actual internal temperature of the fluid within the housing was taken to assess the accuracy of the estimated temperature. Oil temperature and environmental conditions such as ambient temperature and wind speed could be independently controlled in the experimental apparatus. The environmental conditions including ambient temperature were changed at each of time T₁ and T₂, although the actual internal oil temperature does not change throughout the period that T₁ and T₂ are varied.

Results are shown in FIG. 12. The measured temperature (Actual Oil T) of the fluid within the housing represents the known temperature value. The temperature of the shielded portion of the housing of the tank (Shielded Sensor T) and the exposed portion of the housing of the tank (Exposed Sensor T) were measured, and were used to estimate the internal temperature of the fluid inside the housing (Estimated Oil T) using a transfer function as described above.

As can be seen, the estimated temperature closely tracks the measured temperature (independently obtained using a separate temperature sensor disposed within the housing), particularly after a steady state has been reached shortly after any change in environmental conditions (i.e. shortly after the ambient temperature was changed at each of T₁ and T₂). In contrast, neither the Shielded Sensor T nor the Exposed Sensor T are particularly close to the Actual Oil T, demonstrating the need for an alternative method of determining the internal oil temperature.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. Apparatus capable of non-invasively estimating a temperature inside a housing, the apparatus comprising:
an environmentally shielding portion shaped and configured to shield at least a portion of the housing from prevailing environmental conditions;
a first temperature sensing element disposed within the environmentally shielding portion and located to be positionable in thermal contact with the housing when the apparatus is in use;
a second temperature sensing element spaced apart from the environmentally shielding portion, the second temperature sensing element located to be positionable in thermal contact with the housing when the apparatus is in use.

2. Apparatus as defined in claim 1, wherein the second temperature sensing element is largely exposed to prevailing environmental conditions, or is more exposed to prevailing environmental conditions than the first temperature sensing element.

3. Apparatus as defined in claim 1, wherein the first temperature sensing element and/or the second temperature sensing element is located to be positionable adjacent to the housing when the apparatus is in use.

4. Apparatus as defined in claim 1, wherein the first temperature sensing element and/or the second temperature sensing element is located to be positionable against the housing when the apparatus is in use.

5. Apparatus as defined in claim 1, further comprising a cartridge portion shaped and configured for insertion into a cartridge housing extending inside the housing, the cartridge portion comprising the second temperature sensing element.

6. Apparatus as defined in claim 5, further comprising a sensor for determining that the cartridge portion has been inserted into the cartridge housing.

7. A method of using an apparatus as defined in claim 6, the method comprising:
determining if the cartridge portion has been inserted into the cartridge housing;
if it is determined that the cartridge portion has been inserted into the cartridge housing, using a third thermal sensing element to directly measure the temperature of the fluid contained within the housing; or
if it is determined that the cartridge portion has not been inserted in the cartridge housing, using the first and second thermal sensing elements to estimate the temperature of the fluid contained within the housing.

8. A method as defined in claim 7, wherein the second temperature sensor and the third temperature sensor are the same temperature sensor.

9. A method of estimating a temperature of fluid contained within a housing, the method comprising:
measuring a first temperature at a first external location on the housing, the first external location being sheltered from environmental conditions;
measuring a second temperature at a second external location on the housing, the second external location being exposed to environmental conditions or being more exposed to environmental conditions than the first external location; and
correlating a difference between the first temperature and the second temperature to estimate the temperature of the fluid contained within the housing.

10. An apparatus for estimating a temperature of fluid contained within a housing, the apparatus comprising:
a first thermal sensing element;
a second thermal sensing element;
a heating element positioned outwardly of both the first and second thermal sensing elements; and
thermal insulation differentially positioned relative to the first and second thermal sensing elements.

11. An apparatus as defined in claim 10, wherein the thermal insulation that is differentially positioned relative to the first and second thermal sensing elements comprises thermal insulation interposing either (i) the housing and the second thermal sensing element or (ii) the first thermal sensing element and the heating element.

12. An apparatus as defined in claim 11, wherein the thermal insulation interposes the both the housing and the second thermal sensing element and first and the second thermal sensing elements, but the thermal insulation is not positioned between the housing and the first thermal sensing element.

13. An apparatus as defined in claim 10, wherein the first thermal sensing element is laterally spaced apart from the second thermal sensing element.

14. An apparatus as defined in claim 13, wherein the first and second thermal sensing elements are spaced apart from the housing by the same distance when the apparatus is in use.

15. A method of estimating a temperature of fluid contained within a housing, the method comprising:
(i) measuring a first temperature at a first location proximate the housing;
(ii) measuring a second temperature at a second location, a temperature differential being initially present between the first and second locations;
(iii) if the first temperature is different than the second temperature, activating a heating element positioned outwardly of both the first and second locations;
(iv) repeating steps (i) through (iii) until it is determined that the first and second temperatures are the same; and
(v) determining the temperature of the fluid contained within the housing to be the same as the first and second temperatures.

16. A method as defined in claim 15, wherein the temperature differential between the first and second locations is provided by thermal insulation positioned between either (i) the housing and the second location or (ii) the heating element and the first location.

17. A method as defined in claim 16, wherein the thermal insulation interposes the first and second locations.

18. An apparatus for estimating a temperature of fluid contained within a housing, the apparatus comprising:
a first thermal sensing element;
a second thermal sensing element; and
thermal insulation positioned to be located between the housing and the second thermal sensing element when the apparatus is in use.

19. An apparatus as defined in claim 18, wherein the thermal insulation interposes the first and second thermal sensing elements.

20. A method of estimating a temperature of fluid contained within a housing, the method comprising:
measuring a first temperature at a first location on the housing;
measuring a second temperature at a second location, thermal insulation being positioned between the housing and the second location; and
estimating the temperature of the fluid contained within the housing based on the relationship between the first temperature and the second temperature.

21. A method as defined in claim 20, wherein the thermal insulation interposes the first and second locations.

22. An apparatus as defined in claim 1, further comprising a sensor for measuring ambient temperature of the environment outside the housing.

23. A method as defined in claim 7, the method further comprising:
measuring an ambient temperature of the environment outside the housing; and
using the measured ambient temperature as an additional parameter to estimate the temperature of the fluid contained within the housing based on the relationship between the first temperature and the second temperature.

24. An apparatus as defined in claim 1, further comprising a visual indicator for providing an indication that an external temperature of the housing exceeds a predetermined threshold.

25. A method of using an apparatus as defined in claim 1 to develop a calibration coefficient for a particular style of housing, the method comprising:
measuring an internal temperature of a first housing representative of the particular style of housing;
measuring the temperature recorded by each of the first and second temperature sensing elements to provide first and second temperatures; and
deriving a mathematical relationship between the first and second temperatures to yield the calibration coefficient.

26. The apparatus as defined in claim 1, wherein the housing comprises a housing of a piece of electrical equipment, wherein the piece of electrical equipment optionally comprises a transformer.

27. The method as defined in claim 7, wherein the housing comprises a housing of a piece of electrical equipment, wherein the piece of electrical equipment optionally comprises a transformer.
